(19) United States
(12) Patent Application Publication
(10) Pub. No.: US 2004/0170374 A1
(43) Pub. Date: Sep. 2, 2004

(54) Method and apparatus for converting different format content into one or more common formats

(76) Inventors: Jonathan Clark Bender, Los Angeles, CA (US); Ralph Anthony Cavallaro, Woodland Hills, CA (US); Chad Olsen, Burbank, CA (US); Thomas John Moran, St. Paul, MN (US)

Correspondence Address: DARBY & DARBY P.C., 805 Third Avenue, New York, NY, 10022, US

(21) Appl. No.: 10/366,601

(22) Filed: Feb. 13, 2003

(51) Int. Cl. H04N 5/76

(52) U.S. Cl. 386/46; 386/125

(57) ABSTRACT

A method and apparatus for converting different format content into one or more first common formats. This conversion method allows content that is received in multiple, different formats to be converted into one standard format for manufacturing and, optionally, into an Internet format rather quickly. This method allows the content to be available in both the production master and Internet formats nearly simultaneously. The converted Internet ready content file can be “bundled” with its associated metadata in another step and entered into a database.

### FIELD OF THE INVENTION

The present invention generally relates to the fields of signal processing and communications, and more specifically to the conversion of content signals into a common format.

### BACKGROUND OF THE INVENTION

The proliferation of digital content and the transmission of such content to users around the world have resulted in many different types of signal formats for content. Much of the content available is in multimedia (i.e., audio and/or video) format, including music tracks and video. Furthermore, content can be recorded in either analog or digital form and in many different standards within those formats. Once the content is recorded, it may be used for many purposes, including the creation of a master copy of the content from which additional copies can be made, as well as digital copies which can be transmitted over the Internet or an intranet.

One of the reasons for having a common format for content is the need to mass produce the content for general consumption by the public. The mass production of content is a very large industry, with music and video being two of the major types of content that are mass produced. Both the music and video industries utilize content signals in many different formats and both industries require the conversion of the different type content signals into one or more standard content formats for mass production.

The music industry, in particular, utilizes content signals provided in many different formats. These different format content signals must then be converted into a single common format so a master recording can be produced. The master recording is then used to make all subsequent copies. The format of the master recording is typically not an Internet compatible format.

In order to provide content over the Internet, the content needs to be converted to any number of digital formats used over the Internet. This signal conversion is typically performed after production of the first copy and usually involves the copy being delivered to a third party provider who converts the copy to the proper Internet-compatible digital format.

With the current advancements in Internet technology, metadata can also be transferred with the content file. Metadata refers to additional data related to the content and may include track and artist information, as well as images. In presently known systems, a third party provider creates the metadata by keying it in from the CD jacket as well as scanning in images. This procedure is time consuming, manually intensive and prone to a high rate of error.

A disadvantage of current content production systems is the difficulty in having multiple production facilities around the world concurrently make physical copies of the same content. Currently, if a manufacturer wishes to have one production facility produce copies concurrently with another production facility, a new master must be made from the original master and then physically delivered to the other production facility. This process is inefficient and must be performed with great care so as to not damage the new master.

Additionally, there are security concerns when shipping a master to other production facilities at different locations throughout the world. Someone can intercept the master long enough to make a pirated copy of the master and then send the master along to its intended destination. in higher quality copies, and thus make the illegal product more of a substitute for the legal product. Additionally, the use of a production master to make illegal copies will result in the availability of the pirated copies prior to the release date of the legal copies.

Another problem arising from conventional production practices is that of lag time. Conventional processes require the creation of a master and a copy before either another master or Internet ready formatted content is available for use. This inherently slows down the process of quickly converting to other formats, e.g. for Internet distribution.

A practice of companies in the music industry is to maintain a library database which contains a list of the content owned or managed by that company as well as an identification of the format for each piece of content. Currently, most library databases are maintained manually, with the information about each new piece of content being manually entered. Currently, the compilation and entry of information into the company's database is separate from the data collection carried out by the third party providers. Thus, there is a duplication of effort, with both the third party provider and the company inputting the same information. Alternatively, to avoid this duplication, there must be some form of arrangement between the company and the third party to exchange and share such information.

Thus, there is a need for a method and a system to simplify all of the above procedures and streamline them into an efficient process.

### SUMMARY OF THE INVENTION

The present invention relates to a method and apparatus for converting different format content into one or more common formats. This conversion method allows content that is received in different formats to be converted into one standard format for manufacturing and, optionally into an Internet format, rather quickly. This method allows the content to be available in both the production master and Internet formats nearly simultaneously. The converted Internet ready content file can be related to its associated metadata in another step. The converted file and its associated metadata can then be entered into a number of databases, such as a library database which contains all the information required for a manufacturer to keep track of its content, as well as a user database which allows access to the converted file and, once in the database, users can download the content, for a fee, for their personal use.

### BRIEF DESCRIPTION OF THE DRAWINGS

The above and still further objects, features and advantages of the present invention will become apparent upon consideration of the following detailed description of a specific embodiment thereof, especially when taken in conjunction with the accompanying drawings wherein the reference figures are utilized to designate like components, and wherein:

FIG. 1 is a block diagram illustrating the system of the present invention; and

FIG. 2 is a flow diagram illustrating the process of converting primary data into second common format primary data.

### DETAILED DESCRIPTION OF THE DRAWING FIGURES

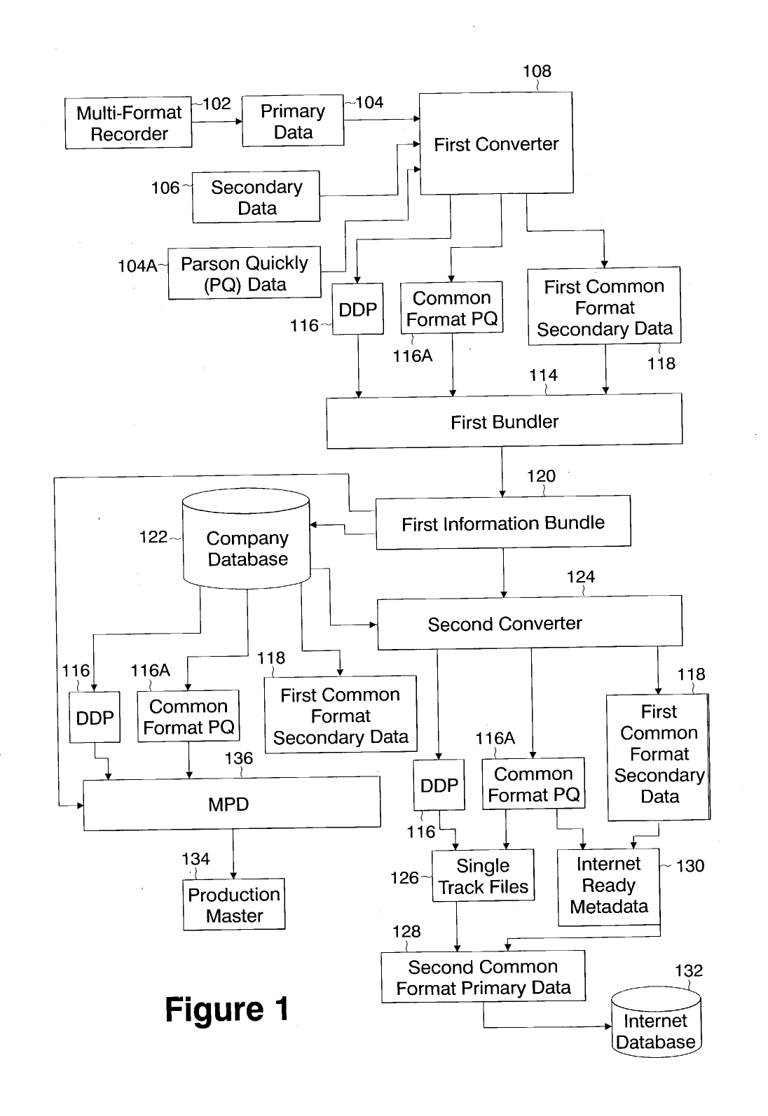

Referring now to FIG. 1, a system in accordance with the present invention is illustrated. First, a multi-format recorder 102 records the primary data or ‘raw’ content 104 in any number of original formats. The original formats will differ given the industry and the preferred original formats for the music recording industry are described below only as an example. Raw content 104 can be recorded in different formats, including analog or digital, and can be recorded on different media, including ¾ inch tape (1630 U-Matic), 8 millimeter tape (8 MM Exabyte) Digital Audio Tape (DAT) or Recordable Compact Disks (CDR). Next, raw content 104 is delivered to the manufacturing facility. Included with raw content 104 is timing data also known in the music industry as Parson Quickly (PQ) data 104A. PQ data 104A is digital information included with the audio files and contains the precise timing of every second of the raw content, including both the location and length of the audio track as well as the “silence” between tracks. PQ data 104A acts like a reference file for the raw content 104 because it allows a user to reference the exact location of a track in raw content 104. Also, accompanying raw content 104 is usually secondary data or raw metadata 106, which may include text data. Raw metadata 106 may be created from manually inputted or scanned data. Raw metadata 106 that can be included with raw content 104 includes photos, transcripts (e.g., song lyrics), royalty information, production information, personal information about the creator of the content and advertising. Raw metadata 106 is usually provided in different formats (e.g., Microsoft® Word® or Corel® WordPerfect® and .jpg or .gif formats).

Next, a first converter 108 takes raw content 104 and converts it to a first common format primary data 116 (e.g., DDP) readable by a Master Production Device (“MPD”) 136. DDP is a well known format and is a combination of both audio tracks and text information. Although the audio portion of the DDP format is typically in .Wav format, which is Internet compatible, the text format is not a standard format used over the Internet. An additional limitation of the DDP format is that it cannot store image data. Thus, the DDP format cannot be easily distributed over the Internet for use by either the music companies or third party users. The present invention addresses these and other problems.

First converter 108 is a device and/or software that receives raw content 104 in any of the many formats that raw content 104 can be recorded in and then converts raw content 104 into one or more different formats, including a first common format primary data 116 that MPD 136 can read. Additionally, first converter 108 uses PQ data 104A to determine the length of the individual tracks, and this information is used in converting raw content 104. PQ data 104A is also converted into a common format PQ 116A, which may also be readable by MPD 136.

Additionally, first converter 108 can relate each track to an unique identifier for further identification. For example, the International Standard Recording Code (ISRC) is a unique 12 digit identifier given to every recording produced by the music industry and is standard across the entire music industry. Music industry convention also identifies audio files in a number of different ways depending on how the audio files are arranged. An audio file designated as a “track” means that it is related to an album, or group of audio files, and can be identified by its grouping relative to the other audio files in the group. For example, an audio file can be identified as track 3 of album X. An audio file designated as a “recording” can have the exact musical content as the “track” but is identified as it stands alone and is not linked to an album. First converter 108 can associate these identifiers with raw content 104 and also may take raw metadata 106 and combine and convert it to a first common format secondary data 118 that the manufacturing systems can read and accept (e.g., delimited text or an extensible markup language file (.XML)).

First common format primary data 116, common format PQ 116A, and first common format secondary data 118 are provided to a first bundler 114 which bundles together first common format primary data 116, common format PQ 116A and first common format secondary data 118 into a first information bundle 120. This may be accomplished using known file compression techniques or bundling software (e.g., PKZIP® or STUFFIT®). The bundling process will not merge the files, but rather will keep them as separate files, grouped under one file name. The first common format data files 116, 116A and 118 are bundled for numerous reasons. Bundling the files allows for easy and simple transmission and storage, since only one file is being handled instead of a minimum of three. Additionally, the files may need to be stored in an interim location since the procedures later on in the process may or may not happen substantially simultaneously after first converter 108 converts the files. First information bundle 120 simplifies storage, retrieval, and transmission because it lowers the probability that one of the first common format files will be misplaced, deleted or lost.

First information bundle 120 is communicated to one or all of company database 122, MPD 136 or a second converter 124. Company database 122 may be the initial storage location for first information bundle 120 and then may transmit first information bundle 120 to MPD 136, or alternatively MPD 136 may receive first information bundle 120 directly from first bundler 114. Company database 122 may be a catalogue of the entire content inventory of the company and may contain information related to an album or track regarding the artist, royalty information, which production facilities are producing copies, and quantity of copies sold.

Second converter 124 receives first information bundle 120 either directly from first bundler 114 or from company database 122. Second converter 124 receives first information bundle 120 nearly simultaneously with company database 122, regardless of what source communicated first information bundle 120. The system now divides into two separate systems, one system for producing copies of the content (using, e.g. the MPD) and a second system involving second converter 124.

Second converter 124 performs multiple tasks, including unbundling first information bundle 120 into first common format primary data 116, common format PQ data 116A, and first common format secondary data 118. Wherein the first common format for the primary data may not be the same as the first common format for the secondary data. Next, second converter 124 operates on first common format primary data 116 by dividing the single file containing multiple tracks into individual single track files 126 using common format PQ data 116A as a guide. Since common format PQ data 116A contains all of the timing information for first common format primary data 116, it can be used as a template to divide the one multiple track first common format primary data 116 into single track files 126 quickly and easily.

As the single track files 126 (which may be in .Wav format) are divided, they may also be nearly simultaneously converted into a second common format primary data 128. This conversion process may also convert the format of single track files 120 into other standard formats (e.g., MPEG) or automatically create and name a directory structure for all the tracks of an album. Grouping the single track files 126 can thus create a virtual album. Second common format primary data or Internet ready data 128 may be named in a manner which identifies the master recording and the particular track number. The file naming schemes can be performed numerous ways. One particular scheme is that every file is named using its individual ISRC number. Another naming scheme is to assign the related single track files 126 and the album a Uniform Product Code/European Article Number (UPC/EAN) and then assign each single track file 126 a number in relation to its play order on the album. Both naming schemes utilize information supplied from first converter 108. Additionally, second converter 124 may convert first common format secondary data 118 into a second common format secondary data or Internet ready metadata 130 (e.g., .XML). First common format secondary data 118 may also be divided so the related metadata is tailored and associated to each single track file 126 and may also be left whole so it may be associated to the entire album. Once the content and metadata are converted from the manufacturing formats (116, 118) to the Internet formats (128, 130), the Internet ready data 128 and Internet ready metadata 130 may be related to each other, so the audio files and the related content are linked. Also, the second common format for the primary data may not be the same as the second common format for the secondary data. Lastly, the related files may be sent to an Internet Database 132, which can then categorize, transmit, store or allow third party access to the files.

Nearly concurrently with the actions of second converter 124, MPD 136 is also performing tasks on first information bundle 120. MPD 136 unbundles first information bundle 120 into first common format primary data 116, PQ data 116A and first common format secondary data 118. MPD 136 (e.g., Laser Beam Recorder) may produce a corresponding production master 134 that may be the template from which all commercial copies are mass produced. First common format secondary data 118 may also be used to produce material identifying first common format primary data 116, including CD jackets and lyric sheets.

Both company database 122 and Internet database 132 can be constructed using any commercial database product (e.g., Microsoft® Access®) and are designed to record an entry for each file (126, 128). Internet database 132 may also be designed to record information as an entry for each file within Internet ready data 128. For example, Internet database 132 may be designed to record the different file formats the data has been converted into, specific information on each segment of the data and specific information entered into the metadata.

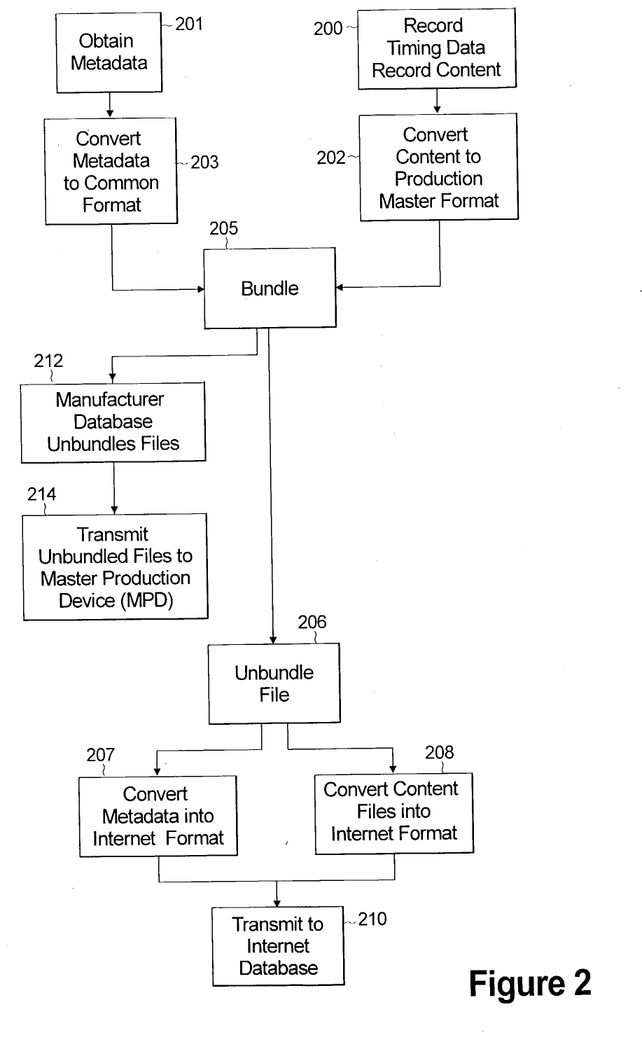

Referring now to FIG. 2, a method in accordance with the present invention is illustrated. It is understood that the method relates to the music industry, but the present invention may be utilized in other industries as well. First, original content recordings are recorded using any one of a number of different formats, creating the primary data and the PQ data (step 200). Next, the primary data and PQ data are converted into the first common format primary data, i.e. the standard format used to create the production master, (e.g., DDP) (step 202). Similarly, secondary data, metadata, is obtained from different sources and may be in any of a number of formats (step 201). The metadata is then converted to a first common format secondary data (step 203). Then the first common format primary data, PQ, and first common format secondary data files are bundled together into a first information bundle for ease of transmission (step 205). The first information bundle can then be communicated to either the second converter, the company database or both.

Once the second converter receives the bundled file it then unbundles the file into the first common format primary data, PQ and first common format secondary data portions (step 206). For the first common format primary data, the second converter uses the PQ data to divide the single content file containing multiple tracks into individual single track files. The individual files are converted into a second common format primary data, i.e., an Internet ready file format (e.g., .WAV) (step 208). The individual files are named accordingly and the naming scheme may include identifying the master recording and the particular track number. A directory structure may also be created to relate the tracks with the album and relate the metadata with the tracks. The second converter also converts the first common format secondary data into second common format secondary data, i.e., an Internet ready format, for example, an extensible markup language file (.XML) (step 207). Both the track and the metadata files are transmitted to the Internet Database, which records the information and places the files in the appropriate locations for access by the public (step 210).

Additionally, the company database receives the first information bundle and unbundles it (step 212). It then transmits the first common format primary data and the PQ data to the MPD for creating a production master (step 214). Once the first common format primary data file is received by the MPD, a production master is created and the standard reproduction of copies can occur. Additionally, the first common format secondary data file containing the artwork and text related to the file can be easily converted into a CD jacket with images, lyrics, and production information.

An additional benefit of the present invention is the ability to electronically transmit all of the information necessary to create a physical production master to a second manufacturing facility located anywhere in the world so the second manufacturing facility may create a production master nearly simultaneously with the first manufacturing facility. Instead of the lengthy and easily intercepted method of creating a copy and shipping it to the desired location, the files can now be transmitted over the Internet to the second manufacturing facility and the security of the transmission may be increased using encryption technology. Using the current invention, the second manufacturing facility has the ability to create a production master without undue delay and nearly simultaneously with that of the first production facility. Also, the present invention removes the need for physically shipping the production master and thus the problem of breakage or diversion of the production master during shipping are solved.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed:

1. A method for converting data comprising the following steps:
(a) obtaining primary data in a first original format;
(b) obtaining secondary data in a second original format;
(c) converting the primary data into first common format primary data;
(d) converting the secondary data into first common format secondary data;
(e) transmitting the first common format primary data and the first common format secondary data to a second converter;
(f) at the second converter, converting the first common format primary data to second common format primary data;
(g) at the second converter, converting the first common format secondary data to second common format secondary data; and
(h) relating the second common format primary data with the second common format secondary data.

2. The method of claim 1, further comprising the steps of:
(a) creating a reference file comprising information related to an individual portion of the primary data;
(b) prior to step (e), bundling the first common format primary data, the first common format secondary data and the reference file into a first information bundle;
(c) transmitting the first information bundle to a production facility; and
(d) transmitting the first information bundle to the second converter, wherein the second converter unbundles the first information bundle.

3. The method of claim 1, further comprising the step of transmitting the related second common format primary data and the second common format secondary data to a storage database.

4. The method of claim 1, further comprising the step of identifying the second common format primary data with a unique identifier.

5. The method of claim 1, wherein a first converter is operable to perform steps (c) and (d).

6. The method of claim 1, wherein the conversion process of step (f) divides the second common format primary data into one or more portions of second common format primary data.

7. The method of claim 2, further comprising the step of referencing the reference file to convert the first common format primary data to the second common format primary data.

8. The method of claim 7, wherein the second converter references the reference file to convert the first common format primary data to the second common format primary data.

9. The method of claim 2, wherein the reference file is PQ data.

10. The method of claim 1, wherein the second common format primary data and the second common format secondary data are Internet compatible.

11. The method of claim 1, wherein the primary data comprises music.

12. The method of claim 1, wherein the secondary data comprises text and images.

13. The method of claim 1, wherein the original format is selected from the group consisting of ¾ inch tape, 8 millimeter tape, Digital Audio Tape and Recordable Compact Disks.

14. A system for converting data comprising:
a first converter operable to convert a primary data file recorded in an original format into a first common format primary data file and operable to convert a secondary data file recorded in an original format into a first common format secondary data file, wherein said first converter transmits the first common format primary data file and the first common format secondary data file to a second converter;
the second converter operable to convert the first common format primary data file to a second common format primary data file and is operable to convert the first common format secondary data file to a second common format secondary data file, wherein the second converter is operable to relate the second common format primary data file with the second common format secondary data file.

15. The system of claim 14, wherein the primary data file comprises one or more individual primary data files, wherein the system further comprises:
a reference file comprising information related to the individual primary data files and the primary data file;
a bundler which combines the first common format primary data file, the first common format secondary data file and the reference file into a first information bundle, wherein the bundler transmits the first information bundle to a production facility and the second converter, wherein the second converter unbundles the first information bundle.

16. The system of claim 14, further comprising:
a memory storage including a database for receiving the related second common format primary data file and the second common format secondary data file transmitted from the second converter.

17. The system of claim 14, wherein the second converter identifies the second common format primary data file with an unique identifier.

18. The system of claim 14, wherein the second converter is operable to divide the second common format primary data file into individual second common format primary data files.

19. The system of claim 14, wherein the second converter is operable to use the reference file to convert the first common format primary data file to the second common format primary data file.

20. The system of claim 14, wherein the second converter is operable to use the reference file to divide the second common format secondary data file into individual second common format secondary data files.

21. The system of claim 14, wherein the reference file is PQ data.

22. The system of claim 14, wherein the second common format primary data file is Internet compatible.

23. The method of claim 14, wherein the primary data file comprises music.

24. The method of claim 14, wherein the secondary data file comprises text and images.
